(19) United States
(12) Patent Application Publication
(10) Pub. No.: US 2025/0285310 A1
(43) Pub. Date: Sep. 11, 2025

(54) METHOD FOR MAPPING A SPATIAL DISTRIBUTION OF A CHARACTERISTIC

(71) Applicant: COMMISSARIAT A L'ENERGIE ATOMIQUE ET AUX ENERGIES ALTERNATIVES, Paris (FR)

(72) Inventors: Lionel HERVE, Grenoble Cedex 09 (FR); Stéphane BONNET, Grenoble Cedex 09 (FR)

(73) Assignee: COMMISSARIAT A L'ENERGIE ATOMIQUE ET AUX ENERGIES ALTERNATIVES, Paris (FR)

(21) Appl. No.: 19/073,871

(22) Filed: Mar. 7, 2025

(30) Foreign Application Priority Data
Mar. 9, 2024 (FR) FR2402380

(51) Int. Cl. G06T 7/60

(52) U.S. Cl. CPC G06T 7/60; G06T 2207/10064; G06T 2207/10116

(57) ABSTRACT

A method of reconstructing a spatial distribution of a characteristic (F) in an object, including a) acquisition of measurements (M) by a sensor, each measurement being able to be estimated a linear operator ((HF),P*F, [symbol] (F)), applied to the spatial distribution of the characteristic (F), forming a forward model; b) with a processing unit, reconstruction of the spatial distribution of the object characteristic, by iterative minimization of an error, each iteration comprising an update of the spatial distribution of the object characteristic; where in step b), the minimized error includes a data attachment component (ε_{D}(f), ε_{D} (F)) including a deviation between the acquired measurements and the measurements estimated by the forward model; a regularization component (ε_{R} (f), ε_{R} (F)), including a sum of a norm of a spatial gradient of the feature, determined at different coordinates in the object.

### TECHNICAL FIELD

The technical field of the invention is the mapping of a characteristic of an object from non-destructive measurements taken in front of this object.

### PRIOR ART

Fluorescence imaging is a technique for localizing fluorescent markers in the human or animal body. One of the main applications is the localization of fluorescent markers, or fluorophores, which target cells of interest, such as cancer cells. The protocol involves injecting these markers into the organism before fluorescence imaging, during which fluorescence images are acquired. A reconstruction algorithm is then used to determine the position of the fluorophores within the object under examination. This algorithm generates fluorescence map, where each element corresponds to a fluorescence intensity at different positions in the object. A distinctive feature of the reconstruction is that the fluorescence map contains both positive and zero elements.

Reconstruction algorithms have been described, for example in WO2010103026.

In fields other than fluorescence imaging, other positivity-constrained reconstruction algorithms have been described in:
Daube-Witherspoon M “An iterative image space reconstruction algorithm suitable for volume ECT”. IEEE transactions on medical imaging 5(2): 61-66, 1986;
or in D. Seung and L Lee “Algorithms for non negative matrix factorization. Advances in neural information processing systems”, 13:556-562, 2001

The inventors propose an algorithm for reconstructing a spatial distribution of a characteristic within an object, enabling results that closely approximate physical reality in the object, while requiring minimal memory for implementation. The algorithm is applicable to fluorescence imaging, but can also be extended to other analytical modalities such as image deconvolution.

### DESCRIPTION OF THE INVENTION

A first object of the invention is a method of reconstructing a spatial distribution of a characteristic within an object, wherein the object is discretized into spatial coordinates within a reference frame that comprises at least one axis, the method comprising:
a) acquiring measurements by a sensor, positioned in front of the object, and defining a forward model to estimate said measurements, the forward model comprising a linear operator, applied to the spatial distribution of the characteristic;
b) reconstructing the spatial distribution of the characteristic of the object, at each spatial coordinate, by minimizing an error during iterations, where each iteration is assigned an index, each iteration comprising an update of the spatial distribution of the characteristic of the object, the first iteration starting from an initial spatial distribution,
wherein in step b), the minimizing the error comprises calculating:
   a data fidelity term, which represents a deviation between the acquired measurements and the measurements estimated by the forward model;
   a regularization term, comprising a sum of a norm of a spatial gradient of the characteristic, determined at different coordinates in the object;
wherein each iteration comprises updating a previous spatial distribution, corresponding either to the initial spatial distribution or to a spatial distribution resulting from a previous iteration, wherein the update comprises a product, for each spatial coordinate, of
   the previous spatial distribution;
   an adjoint operator of the forward model applied to the acquired measurements;
   for at least one axis of the reference frame, an element-wise multiplication of:
      the previous spatial distribution translated, along the axis of the reference frame, by at least one unit, in an increasing direction;
      of said prior spatial distribution translated, along the axis of the reference frame, by at least one unit, in a decreasing direction.

The update may comprise, in each spatial coordinate, a multiplication of the previous spatial distribution by a linear combination of products, each product being associated with an axis of the reference frame, and comprising an element-wise (element by element) multiplication of:
the previous spatial distribution translated, along the axis of the reference frame, by at least one unit, in an increasing direction;
the previous spatial distribution translated, along the axis of the reference frame, by at least one unit, in a decreasing direction.

Each element-wise multiplication may comprise the inverse of a norm of the spatial gradient of the prior distribution for said coordinate.

The update may use the following expression:

$${F}^{k - 1} ⊙ \frac{{Q}^{-} ( {F}^{k - 1} ) + {H}^{′} ( M )}{{Q}^{+} ( {F}^{k - 1} )}$$

where:

$${Q}^{+} ( {F}^{k - 1} ) = {H}^{′} ( H ( {F}^{k - 1} ) ) + λ [ n {Γ}^{′} ⊙ {F}^{k - 1} + {\sum }_{Δ} {S}_{Δ \to } [ {Γ}^{′} ⊙ {S}_{← Δ} {F}^{k - 1} ] ] ;$$

$${Q}^{-} ( {F}^{k - 1} ) = λ [ {Γ}^{′} ⊙ {\sum }_{Δ} {S}_{← Δ} {F}^{k - 1} + {\sum }_{Δ} {S}_{Δ \to } [ {Γ}^{′} ⊙ {F}^{k - 1} ] ] ;$$

M corresponds to the acquired measurements;
F^{k-1} is the previous spatial distribution;
Γ′ is a spatial distribution of the inverse of a norm of a spatial gradient of the previous spatial distribution, in each coordinate of the object;
Δ corresponds to each axis of the;
S_{←Δ} is an operator for shifting one or more units along the Δ axis, in the downward direction;
S_{Δ→} is an operator for shifting by one or more units along the Δ axis, in an increasing direction;
n corresponds to the number of axes considered;
λ is a positive real;
H is the forward model operator;
H′ is the adjoint operator of the forward model;
⊙ is the Hadamard product.

Step a) may comprise forming at least one image of the object, each image forming a spatial distribution of measurements acquired by the sensor.

According to one possibility:
the sensor is an image sensor, configured to form an image of the object at an emission wavelength;
the object may comprise a fluorophore emitting light at the emission wavelength under the effect of illumination at an excitation wavelength;
in step a), at least one image of the object is acquired when the object is illuminated at the excitation wavelength, different from the emission wavelength, each measurement being representative of an amount of light emitted by the fluorophore at different coordinates in the object.

According to one possibility:
the sensor is an image sensor, configured to form an image of the object at an emission wavelength;
the object may absorb light at the emission wavelength,
in step a), at least one image of the object is acquired when the object is illuminated at the emission wavelength, each measurement being representative of an amount of light absorbed at different coordinates in the object.

According to one possibility:
the sensor is designed to detect an ionizing X-ray or gamma ray;
in step a), the object is irradiated with an X-ray or gamma-ray beam, each measurement being representative of absorption of the beam by the object.

The forward model can include a Radon transform.

The characteristic may be a characteristic of emission or reflection or backscattering of an electromagnetic wave or acoustic wave.

A second object of the invention is a processing unit, configured to implement step b) of a method according to the first object of the invention from measurements made by a sensor positioned facing an object, so as to obtain a spatial distribution of a characteristic of the object.

A third object of the invention is a measurement system, configured to reconstruct a spatial distribution of a characteristic of an object, the object being discretized according to different spatial coordinates associated with a reference frame, and comprising:
a sensor, arranged facing the object, and configured to acquire measurements, each measurement being able to be estimated a linear operator, applied to the spatial distribution of the characteristic, forming a forward model;
a processing unit, configured to implement step b) of a method according to the first object of the invention.

The invention will be better understood on reading the examples of embodiments presented, in the following description, in connection with the figures listed below.

### FIGURES

FIG. 1 shows a device for implementing the invention, in order to reconstruct a fluorescence map of an object.

FIG. 2 shows the pulse response of the sensor described in connection with the device shown in FIG. 1.

FIG. 3 shows an image acquisition using the device described in relation to FIG. 1.

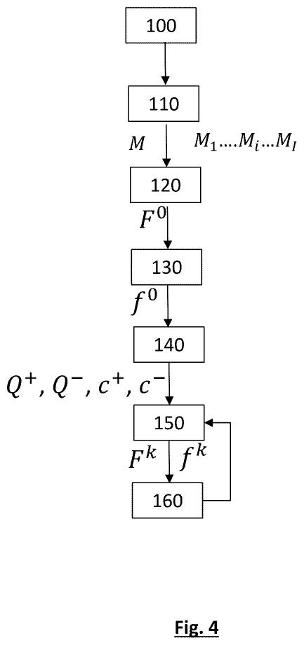

FIG. 4 shows a function being upper-bounded by a parabola.

FIG. 5 shows the main stages of a method according to the invention.

FIGS. 6A to 6D are images resulting from a reconstruction of a fluorescence map of a mouse embryo.

### SPECIAL PRODUCTION METHODS

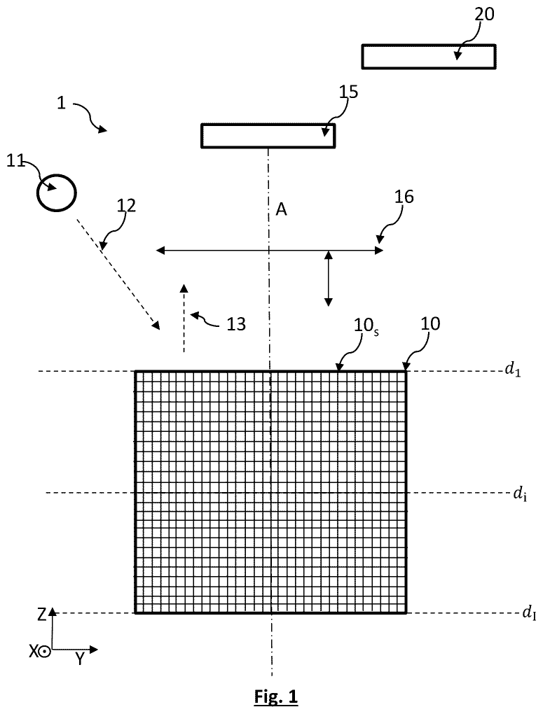

FIG. 1 shows a device for implementing the invention. In this example, the device is configured to acquire images of a sample, in order to locate fluorescence light sources within the object. Fluorescence imaging is one of the analysis modalities that can be implemented. Other possible modalities are described later, and may possibly include X-ray imaging or X-ray tomography, or reconstruction of light-absorbing areas within in a object.

The device includes a light source 11, configured to illuminate a sample 10. The sample is a solid volume to be analyzed. When illuminated by the light source, the sample emits emission light. The light source emits illumination light 12 in a specific spectral illumination band. Part of the light emitted by the light source propagates through the sample. Under the effect of illumination, the sample emits fluorescent light 13 in an emission spectral band.

The light source can be a laser source or a light-emitting diode. The light source can coupled to an optical fiber, with the light emitted by the light source guided towards the sample by an optical fiber.

The sample contains fluorophores, which emit fluorescent light in the emission spectral band when illuminated within an excitation spectral band. The goal is to determine the spatial distribution of the fluorophores within the sample. This involves reconstructing a three-dimensional spatial distribution of light emission within the sample. This allows for the identification of regions within the sample with a high fluorophore concentrations.

The sample is, for example, biological tissue, which is analyzed in order to identify singularities. The objective is to identify local concentrations of fluorophores in the sample, which can be used to help determine a pathological condition.

The sample 10 is discretized into voxels, known as “object voxels”. Each object voxel represents an elementary volume of the sample. Each object voxel may be, for example, be a volume of 100 nm×100 nm×100 nm to 10 μm×10 μm×10 μm. In the following, each object voxel is identified by a three-dimensional spatial coordinate r within an XYZ reference frame. N corresponds to the total number of object voxels in the discretized object.

The device includes a pixelated image sensor 15, configured to form an image of the sample. The image sensor 15 is coupled to an optical system 16, which conjugates an object plane, known as the focal plane, with the image sensor. The image sensor and optical system are aligned along an optical axis A. The assembly formed by the image sensor and the optical system is configured so that the focal plane can be moved parallel to the optical axis A. The optical system may combine an objective and a tube lens. The image sensor can be a CMOS sensor. The focal plane can be adjusted to different depths within the sample.

Alternatively, the image sensor can be combined with a confocal diaphragm, enabling successive observation of different sections of the sample.

The image sensor is designed to acquire images in different planes at different depths in the sample. The sample is bounded by a surface S, forming an interface between the sample and a surrounding medium into which the image sensor extends. The surrounding medium is generally air. A depth in the sample corresponds to a distance from the surface S, parallel to the optical axis A. The image sensor can be coupled to a spectral filter, for example a bandpass filter, to detect light in the spectral emission band.

The device includes a processing unit 20, configured to process the images formed by the image sensor, in order to estimate the spatial, three-dimensional distribution of fluorescence emission in the sample.

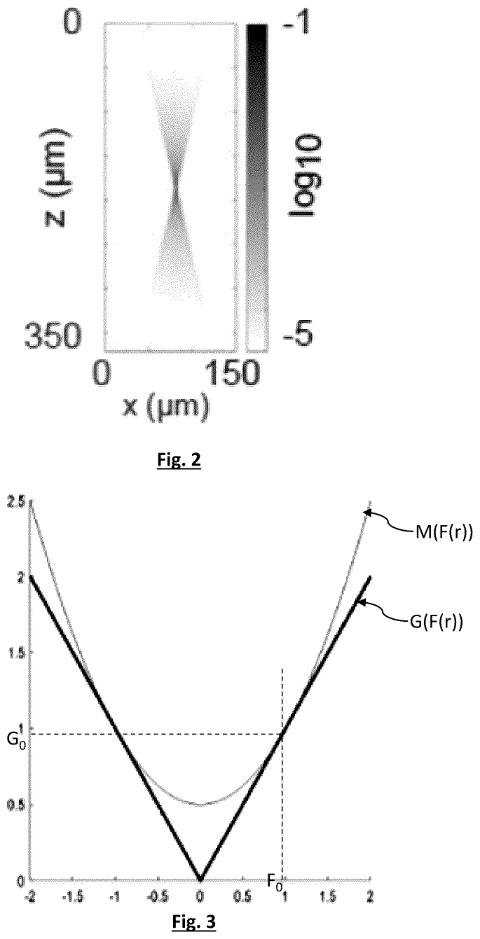

The spatial distribution of fluorescence emission, denoted as F, can be related to the measured data using an additive noise model:

$$M = P * F + B \qquad ( 1 )$$

where:
F is a 3D tensor, each element F(r) of which is the fluorescence intensity in an object voxel at a three-dimensional coordinate r: this is what needs to be estimated.
M is the set of fluorescence images formed by the image sensor: this corresponds to the set of measurements structured as a 3D tensor, at the same discretization step as F. Measurements M(r′) are defined for image voxels r′. The number of image voxels is N′, with N′=N;
P is an operator representative of the instrument response: in this case, P is a 3D tensor, representing an impulse response of the measuring instrument (PSF: Point Spread Function). P is determined using the same spatial discretization step as the tensors M and F. P is determined through modeling and can be recalibrated by experimental measurements. The operator P is of dimension of (N,N′), with, in this example, N′=N. P can be obtained using a Beam Propagation Method, described in Van Toey, J “Beam-Propagation method: analysis and assessment. FIG. 2 shows the PSF of image sensor 15 in an XZ plane. The PSF value at each coordinate corresponds to the gray level.
* is the discrete 3D convolution product operator.
B is a noise term. It is a 3-D tensor of the same dimension as M.

In this application, both instrument response P and fluorescence intensity are positive. The noise term B can be both positive and negative, but remains low, ensuring that the measurement M is also positive.

Image voxels are distributed according to a regular sampling step Δx, Δy, Δz respectively along X, Y and Z axes. Z corresponds to the optical axis. Object voxels are distributed according to a discretization step Δx, Δy, nΔz, where n corresponds to the refractive index of the object, which is assumed to be homogeneous.

For example, object and measurement sampling may comprise 2000×2000 points along both of the X and Y axes, and 1000 points along the Z axis.

One step in the reconstruction process is to estimate the measurements \hat{M}=P*F to approximate M. This involves determining an error term ε, between \hat{M} and M. More generally,

\hat{M}=H(F)
where H is the forward model operator, which estimates measurements based on the spatial distribution of the characteristic (i-e fluorescence intensity) within the object.

A first option is to minimize an error ε_{D} corresponding to a comparison of \hat{M} and M:

$${ε}_{D} ( F ) = {‖ \hat{M} ( F ) - M ‖}^{2} \qquad ( {1}^{′} )$$

ε_{D} (F) represents a data fidelity term. ε_{D} (F) is a scalar quantity.

Preferably, the error to be minimized combines a data fidelity term and a regularization term. The data fidelity term is a comparison of the measurements M and their estimate \hat{M}(F). The objective of the regularization term is to obtain a representation of the spatial distribution F of fluorescence that is representative of reality. In particular, the regularization term takes into account a spatial gradient of fluorescence intensity, at each voxel, such that

$$\sqrt{{( \frac{\partial F ( r )}{\partial x} )}^{2} + {( \frac{\partial F ( r )}{\partial y} )}^{2} + {( \frac{\partial F ( r )}{\partial z} )}^{2}} \qquad ( 2 )$$

The regularization term can be a total variation, such as

$${ε}_{R} ( F ) = T V ( F ) = {\sum }_{n} \sqrt{{( \frac{\partial F ( {r}_{n} )}{\partial x} )}^{2} + {( \frac{\partial F ( {r}_{n} )}{\partial y} )}^{2} + {( \frac{\partial F ( {r}_{n} )}{\partial z} )}^{2}} \qquad ( 3 )$$

where rₙ denotes the spatial position of the nth voxel. ε_{R} (F) is a scalar quantity.

The regularization term corresponds to a sum of the L2 norm of the spatial gradient of the fluorescence distribution.

Expression (3) defines “total variation”. Other regularization terms are possible, in particular inthe form:

$${\sum }_{n} {( \sqrt{{( \frac{\partial F ( {r}_{n} )}{\partial x} )}^{2} + {( \frac{\partial F ( {r}_{n} )}{\partial y} )}^{2} + {( \frac{\partial F ( {r}_{n} )}{\partial z} )}^{2}} )}^{α} with 0 < α \leq 2. \qquad ( {3}^{′} )$$

In the following example, α=1.

The error to be minimized can be expressed as:

$$ε ( F ) = {ε}_{D} ( F ) + λ {ε}_{R} ( F ) = {‖ M - \hat{M} ( F ) ‖}^{2} + λ TV ( F ) \qquad ( 4 )$$

λ is a weighting factor. λ is a positive real number.

Expression (4) comprises the data fidelity term ε_{D}(F)=∥M−\hat{M}(F)∥² and the regularization term ε_{R} (F)=TV(F). The balance between the two terms (data fidelity and regularization) is controlled by the weighting factor λ.

Taking into account the regularization term ε^{R} helps to denoise the fluorescence map F, which tends to create groups of pixels in which F(r) is homogeneous, the edges of the pixel groups generally being sharp.

### Minimization of the Data Fidelity Term.

$${ε}_{D} ( F ) = \frac{1}{2} {‖ P * F - M ‖}^{2} \qquad ( 5 )$$

Putting (5) into its canonical form yields:

$${ε}_{D} ( F ) = \frac{1}{2} {‖ R ( P ) f - m ‖}^{2} \qquad ( 6 )$$

where R(P)f=vec(P*F) (7) with the vectorization operator vec, which forms a vector where each term is a voxel of P*F
f is a vector of dimension N, with each element f(r) corresponding to a fluorescence intensity, which is assumed to be positive.
R(P) is a matrix, of dimension (N, N), representing the 3-D convolution with the impulse response P.
R(P)f is a vector, of dimension N, each element of which corresponds to the convolution of F by P for each image voxel.

$${ε}_{D} ( F ) = \frac{1}{2} {( R ( P ) f - m )}^{T} ( R ( P ) f - m ) \qquad ( 8 )$$

$${ε}_{D} ( F ) = \frac{1}{2} {f}^{T} {R ( P )}^{T} R ( P ) f - \frac{1}{2} {f}^{T} {R ( P )}^{T} m + \frac{1}{2} {m}^{T} m - \frac{1}{2} {m}^{T} R ( P ) f \qquad ( 9 )$$

m is a vector with each element m(r) of which corresponding to a measurement.

Q_{D} is defined as Q_{D}=R(P)^{T}R(P) (10)
Q_{D} is a symmetric semi-positive definite (SSPD) matrix of dimension N×N.

In general:
a square matrix A is symmetrical if A^{T}=A;
a square matrix A is defined as semi-positive if ∀u≠0, u^{T}Au≥0 where u is a vector of the same size as the matrix. ∀ means “whatever”.

Given (9),

$${ε}_{D} ( f ) = \frac{1}{2} {f}^{T} {Q}_{D} f + {c}^{T} f + cte \qquad ( 11 )$$

c is a vector of dimension N.

$$c = - {R ( P )}^{T} m \qquad ( 12 )$$

because

$$\frac{1}{2} {m}^{T} R ( P ) f = \frac{1}{2} {f}^{T} {R ( P )}^{T} m$$

cte is a constant that does not depend on f:

$$cte = \frac{1}{2} {m}^{T} m . \qquad ( {12}^{′} )$$

As the constant is not involved in the minimization of ε_{D} (f), it can be neglected hereafter.

The matrix Q_{D} can be decomposed into two symmetric matrices, with positive elements, Q_{D}⁺ and Q_{D}⁻, each representing the positive and negative elements respectively of the matrix Q_{D}.

$${Q}_{D} = {Q}_{D}^{+} - {Q}_{D}^{-} \qquad ( 13 )$$

Similarly, the vector c can be decomposed into two vectors of positive elements c⁺ and c⁻, each representing the positive and negative elements respectively of c.

$$c = {c}^{+} - {c}^{-} \qquad ( 14 )$$

Data fidelity error minimization is performed iteratively. Each iteration is assigned an index k. During each iteration, the vector f is updated according to:

$${f}^{k} ← {f}^{k - 1} ⊙ \frac{{Q}_{D}^{-} {f}^{k - 1} + {c}^{-}}{{Q}_{D}^{+} {f}^{k - 1} + {c}^{+}} \qquad ( 15 )$$

The symbol ⊙ represents the Hadamard product (or element-wise product).

In this example, which relates to the deconvolution of a fluorescence measurement, Q_{D} is a matrix of positive elements, since R(P) contains only positive elements, so

$${Q}_{D}^{-} = 0 , and {Q}_{D}^{+} = {Q}_{D}$$

Similarly, c is a vector containing only negative elements (see (12)), so: c⁻=−c.

Expression (15) becomes:

$${f}^{k} ← {f}^{k - 1} ⊙ \frac{{c}^{-}}{{Q}_{D}^{+} {f}^{k - 1}} \qquad ( 16 )$$

Expression (16) can be expressed as:

$${F}^{k} ← {F}^{k - 1} ⊙ \frac{{P}_{R} * M}{{P}_{R} * P * {F}^{k - 1}} \qquad ( 17 )$$

P_{R} corresponds to the tensor P flipped symmetrically around the center. This is an adjoint operator of the previously defined forward model, applied to the measurements M. More generally, if H denotes the operator corresponding to the forward model, H′ denotes its adjoint operator. In this example, H(F)=P*F. The adjoint operator H′ is

$${H}^{′} ( M ) = {P}_{R} * M or$$

$${H}^{′} ( P * {F}^{k - 1} ) = {P}_{R} * P * {F}^{k - 1}$$

Thus, (17) can be expressed as:

$${F}^{k} ← {F}^{k - 1} ⊙ \frac{{H}^{′} ( M )}{{H}^{′} ( P * {F}^{k - 1} )} \qquad ( {17}^{′} )$$

### Regularization Term.

According to (3), the regularization term ε_{R} can be such that:

$${ε}_{R} ( F ) = TV ( F ) = {‖ G ( F ) ‖}_{1} = {\sum }_{n} {\vert G ( F ( {r}_{n} ) ) \vert}_{2} = {\sum }_{n} \sqrt{{( {D}_{X} * F ( {r}_{n} ) )}^{2} + {( {D}_{Y} * F ( {r}_{n} ) )}^{2} + {( {D}_{Z} * F ( {r}_{n} ) )}^{2}} \qquad ( 20 )$$

D_{X} is an “X-axis derivative” operator;
D_{Y} is a “Y-axis derivative” operator;
D_{Z} is a “Z-axis derivative” operator

The term |G(F(r))|₂={square root over ((D_{X}*F(r))²+(D_{Y}*F(r))²+(D_{Z}*F(r))²)} corresponds to the L2 norm of the spatial gradient G(F(r)) of the spatial distribution F at the object voxel r.

It can be shown that whatever F(r):

$${\vert G ( F ( r ) ) \vert}_{2} \leq \frac{1}{2} \frac{{\vert G ( F ( r ) ) \vert}_{2}^{2}}{{\vert G ( {F}_{0} ) \vert}_{2}} + \frac{1}{2} {\vert G ( {F}_{0} ) \vert}_{2} \qquad ( 21 )$$

Expression (21) expresses the fact that |G(F(r))|₂ is bounded by a parabola, tangent at the point G(F₀). The expression of the parabola is

$$\frac{1}{2} \frac{{\vert G ( F ( r ) ) \vert}_{2}^{2}}{\vert {G}_{0} \vert} + \frac{1}{2} \vert {G}_{0} \vert$$

with G₀=G(F₀).

When a real-valued function (in this case |G(F(r))|₂), is majorized and tangent at F₀ by another function M(F(r)), in this case

$$\frac{1}{2} \frac{{\vert G ( F ( r ) ) \vert}_{2}^{2}}{\vert {G}_{0} \vert} + \frac{1}{2} \vert {G}_{0} \vert ,$$

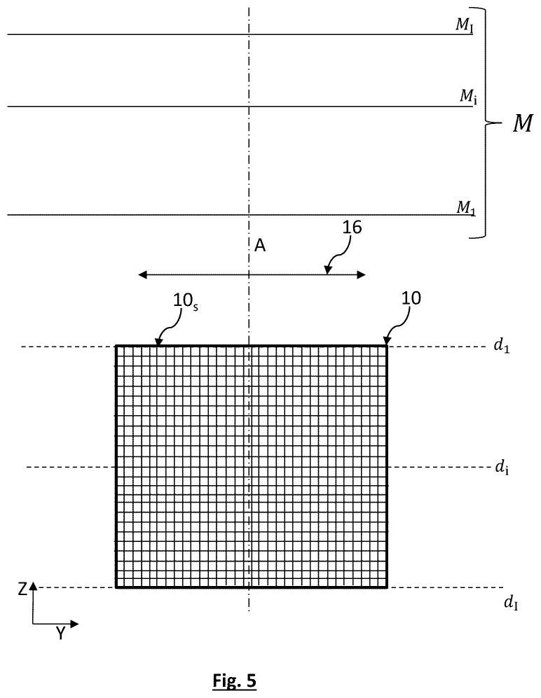

if a point F(r) decreases the value of M(F(r)) then this point also decreases the value of |G(F(r))₂. See FIG. 4. More generally, if a point with abscissa u minimizes M(u), this same point also minimizes |G(u)|.

The fluorescence map F is updated iteratively, with each iteration assigned an index k. k is a positive non-zero integer. For the first iteration, k=1. The first iteration is performed from an initialized fluorescence map F⁰.

Hereafter, |G₀| is defined as to the value of the gradient G(F^{k-1}(r)) at iteration k-1.

$$TV ( F ) \leq \frac{1}{2} {\sum }_{n} \{ \frac{{\vert G ( F ( {r}_{n} ) ) \vert}_{2}^{2}}{{\vert G ( {F}^{k - 1} ( {r}_{n} ) ) \vert}_{2}} \} + \frac{1}{2} {\sum }_{n} {\vert G ( {F}^{k - 1} ( {r}_{n} ) ) \vert}_{2} \qquad ( 23 )$$

As the term

$$\frac{1}{2} {\sum }_{n} {\vert G ( {F}^{k - 1} ( {r}_{n} ) ) \vert}_{2}$$

is constant, it does not contribute to the minimization.

In general,

$${\sum }_{n} {α}^{2} ( {r}_{n} ) β ( {r}_{n} ) = {a}^{T} Ba , \qquad ( 24 )$$

where
a is a vector containing the elements α(rₙ);
B is a diagonal matrix formed by the elements β(r₁) . . . β(r_{N})

The term

$$\frac{1}{2} {\sum }_{n} \frac{{\vert G ( F ( {r}_{n} ) ) \vert}_{2}^{2}}{{\vert G ( {F}^{k - 1} ( {r}_{n} ) ) \vert}_{2}}$$

can be expressed in canonical form as:

$$\frac{1}{2} {f}^{T} {R}^{T} ( {D}_{X} ) Γ R ( {D}_{X} ) f + \frac{1}{2} {f}^{T} {R}^{T} ( {D}_{Y} ) Γ R ( {D}_{Y} ) f + \frac{1}{2} {f}^{T} {R}^{T} ( {D}_{Z} ) Γ R ( {D}_{Z} ) f \qquad ( 25 )$$

Where:
R(D_{X}), R(D_{Y}) and R(D_{Z}) are matrix representations of the respective convolutions with D_{X}, D_{Y} and D_{Z}.
Γ is a diagonal matrix of dimension N×N with elements |G(F^{k-1} (rₙ))|₂

Thus,

$$Γ = [ \begin{matrix}1 / {\vert G ( {F}^{k - 1} ( {r}_{1} ) ) \vert}_{2} & … & 0 \\ ⋮ & ⋱ & ⋮ \\ 0 & … & 1 / {\vert G ( {F}^{k - 1} ( {r}_{N} ) ) \vert}_{2}\end{matrix} ] \qquad ( 27 )$$

Each element on the diagonal of Γ is the inverse of an L1 norm of a spatial gradient at each coordinate rₙ.

### Global Criterion

Using (4), (9) and (25), the following expression is derived:

$$ε ( f ) = {ε}_{D} ( f ) + λ {ε}_{R} ( f ) \leq \frac{1}{2} {f}^{T} {R ( P )}^{T} R ( P ) f - {m}^{T} R ( P ) f + λ [ \frac{1}{2} {f}^{T} {R}^{T} ( {D}_{X} ) Γ R ( {D}_{X} ) f + \frac{1}{2} {f}^{T} {R}^{T} ( {D}_{Y} ) Γ R ( {D}_{Y} ) f + \frac{1}{2} {f}^{T} {R}^{T} ( {D}_{Z} ) Γ R ( {D}_{Z} ) f ] \qquad ( 30 )$$

Q is introduced as:

$$Q = {R ( P )}^{T} R ( P ) + λ [ {R}^{T} ( {D}_{X} ) Γ R ( {D}_{X} ) + {R}^{T} ( {D}_{Y} ) Γ R ( {D}_{Y} ) + {R}^{T} ( {D}_{Z} ) Γ R ( {D}_{Z} ) ] \qquad ( 31 )$$

$$Q = {Q}_{D} + λ [ {Q}_{X} + {Q}_{Y} + {Q}_{Z} ] \qquad ( 32 )$$

$$with$$

$${Q}_{X} = {R}^{T} ( {D}_{X} ) Γ R ( {D}_{X} ) \qquad ( 33 )$$

$${Q}_{Y} = {R}^{T} ( {D}_{Y} ) Γ R ( {D}_{Y} ) \qquad ( 34 )$$

$${Q}_{Z} = {R}^{T} ( {D}_{Z} ) Γ R ( {D}_{Z} ) \qquad ( 35 )$$

The forward derivative is chosen:

$$R ( {D}_{X} ) = [ \begin{matrix}1 & - 1 & & & \\ 0 & 1 & ⋱ & & \\ & 0 & ⋱ & - 1 & \\ & & ⋱ & 1 & - 1 \\ & & & 0 & 1\end{matrix} ] and \qquad ( 36 )$$

$${R ( {D}_{X} )}^{T} = [ \begin{matrix}1 & 0 & & & \\ - 1 & 1 & ⋱ & & \\ 0 & - 1 & ⋱ & 0 & \\ & ⋱ & ⋱ & 1 & 0 \\ & & 0 & - 1 & 1\end{matrix} ] \qquad ( 37 )$$

The R(D_{X}) and R(D_{X})^{T} matrices are used to compute the rate of change along the X axis for each voxel. These are matrix operators used to obtain, for each element of the fluorescence map, expressed here in vector form, a difference between two elements along the X axis. More precisely, each element of the fluorescence map is assigned a coordinate along the X axis. The R(D_{X}) and R(D_{X})^{T} matrices allow the computation of the difference between two fluorescence map elements that are adjacent along the X axis or separated by a given increment along the X axis.

Similarly, the R(D_{Y}) and R(D_{Y})^{T} matrices can be used to obtain, for each element, a rate of change along the Y axis. These are matrix operators used to obtain, for each element of the fluorescence map, expressed here in vector form, a difference between two elements along the Y axis. Each element of the fluorescence map is assigned a Y coordinate. The R(D_{Y}) and R(D_{Y})^{T} matrices allow the computation of the difference between two fluorescence map elements that are adjacent along the Y axis or separated by a given increment along the Y axis.

Similarly, the R(D_{Z}) and R(D_{Z})^{T} matrices can be used to obtain, for each element, a rate of change along the Z axis. These are matrix operators used to obtain, for each element of the fluorescence map, expressed here in vector form, a difference between two elements along the Z axis. Each element of the fluorescence map is assigned a Z-axis coordinate. The matrices R(D_{Z}) and R(D_{Z})^{T} allow a difference to be made between two fluorescence map elements that are adjacent along the Z axis or spaced apart by an increment along the Z axis.

R(D_{X})⁺, R(D_{X})⁻, R(D_{X})^{T+}, R(D_{X})^{T-} are defined as follows:

$${R ( {D}_{X} )}^{+} = [ \begin{matrix}1 & 0 & & & \\ 0 & 1 & ⋱ & & \\ & 0 & ⋱ & 0 & \\ & & ⋱ & 1 & 0 \\ & & & 0 & 1\end{matrix} ] , \qquad ( 38 )$$

$${R ( {D}_{X} )}^{-} = [ \begin{matrix}0 & 1 & & & \\ 0 & 0 & ⋱ & & \\ & 0 & ⋱ & 1 & \\ & & ⋱ & 0 & 1 \\ & & & 0 & 0\end{matrix} ] , \qquad ( 39 )$$

$${R ( {D}_{X} )}^{T +} = [ \begin{matrix}1 & 0 & & & \\ 0 & 1 & ⋱ & & \\ & 0 & ⋱ & 0 & \\ & & ⋱ & 1 & 0 \\ & & & 0 & 1\end{matrix} ] , \qquad ( 40 )$$

$${R ( {D}_{X} )}^{T -} = [ \begin{matrix}0 & 0 & & & \\ 1 & 0 & ⋱ & & \\ & 1 & ⋱ & 0 & \\ & & ⋱ & 0 & 0 \\ & & & 1 & 0\end{matrix} ] \qquad ( 41 )$$

R(D_{X})⁺ and R(D_{X})^{T+} include the positive elements of R(D_{X}) and R(D_{X})^{T} respectively.

R(D_{X})⁻ and R(D_{X})^{T-} include the opposites of the negative elements of R(D_{X}) and R(D_{X})^{T} respectively

Thus: R(D_{X})=R(D_{X})⁺−R(D_{X})⁻

Similarly, the following matrices are defined:
R(D_{Y})⁺ and R(D_{Y})^{T+}, which comprise the positive elements of R(D_{Y}) and R(D_{Y})^{T} respectively.
R(D_{Y})⁻ and R(D_{Y})^{T-}, which comprise the opposites of the negative elements of R(D_{Y}) and R(D_{Y})^{T} respectively;
   with R(D_{Y})=R(D_{Y})⁺−R(D_{Y})⁻.
R(D_{Z})⁺ and R(D_{Z})^{T+}, which comprise the positive elements of R(D_{Z}) and R(D_{Z})^{T} respectively;
R(D_{Z})⁻ and R(D_{Z})^{T-}, which comprise the opposites of the negative elements of R(D_{Z}) and R(D_{Z})^{T} respectively;
   with R(D_{Z})=R(D_{Z})⁺−R(D_{Z})⁻.

According to (33),

$${Q}_{X} = {R}^{T} ( {D}_{X} ) Γ R ( {D}_{X} ) \qquad ( 42 )$$

$${Q}_{X} = ( {R ( {D}_{X} )}^{T +} - {R ( {D}_{X} )}^{T -} ) Γ ( {R ( {D}_{X} )}^{+} - {( R {D}_{X} )}^{-} ) \qquad ( 43 )$$

$${Q}_{X} = {R ( {D}_{X} )}^{T +} Γ {R ( {D}_{X} )}^{+} + {R ( {D}_{X} )}^{T -} Γ {R ( {D}_{X} )}^{-} - {R ( {D}_{X} )}^{T +} Γ {R ( {D}_{X} )}^{-} - {R ( {D}_{X} )}^{T -} Γ {R ( {D}_{X} )}^{+} \qquad ( 44 )$$

Q_{X}⁺ and Q_{X}⁻ are introduced as:

$${Q}_{X}^{+} = {R ( {D}_{X} )}^{T +} Γ {R ( {D}_{X} )}^{+} + {R ( {D}_{X} )}^{T -} Γ {R ( {D}_{X} )}^{-} \qquad ( 45 )$$

Q_{X}⁺ is a symmetrical matrix of positive elements.

$${Q}_{X}^{-} = {R ( {D}_{X} )}^{T +} Γ {R ( {D}_{X} )}^{-} + {R ( {D}_{X} )}^{T -} Γ {R ( {D}_{X} )}^{+} \qquad ( 46 )$$

Q_{X}⁻ is a symmetrical matrix of positive elements.

$${Q}_{X} = {Q}_{X}^{+} - {Q}_{X}^{-} \qquad ( 47 )$$

### Similarly:

$${Q}_{Y}^{+} = {R ( {D}_{Y} )}^{T +} Γ {R ( {D}_{Y} )}^{+} + {R ( {D}_{Y} )}^{T -} Γ {R ( {D}_{Y} )}^{-} \qquad ( 50 )$$

$${Q}_{Y}^{-} = {R ( {D}_{Y} )}^{T +} Γ {R ( {D}_{Y} )}^{-} + {R ( {D}_{Y} )}^{T -} Γ {R ( {D}_{Y} )}^{+} \qquad ( 51 )$$

Q_{Y}⁺ and Q_{Y}⁻ are symmetrical matrices with positive elements.

$${Q}_{Y} = {Q}_{Y}^{+} - {Q}_{Y}^{-} \qquad ( 52 )$$

$${Q}_{Z}^{+} = {R ( {D}_{Z} )}^{T +} Γ {R ( {D}_{Z} )}^{+} + {R ( {D}_{Z} )}^{T -} Γ {R ( {D}_{Z} )}^{-} \qquad ( 53 )$$

$${Q}_{Z}^{-} = {R ( {D}_{Z} )}^{T +} Γ {R ( {D}_{Z} )}^{-} + {R ( {D}_{Z} )}^{T -} Γ {R ( {D}_{Z} )}^{+} \qquad ( 54 )$$

$${Q}_{Z} = {Q}_{Z}^{+} - {Q}_{Z}^{-} \qquad ( 55 )$$

Q_{Z}⁺ and Q_{Z}− are symmetrical matrices with positive elements.

### According to (31) to (35)

$$Q = {Q}_{D}^{+} - {Q}_{D}^{-} + {Q}_{X}^{+} - {Q}_{X}^{-} + {Q}_{Y}^{+} - {Q}_{Y}^{-} + {Q}_{Z}^{+} - {Q}_{Z}^{-} \qquad ( 56 )$$

Knowing that Q_{D}⁻=0.
Q is an SSPD matrix (SSPD standing for semi-positive definite).
Q⁺ and Q⁻ are introduced as:

$${Q}^{+} = {Q}_{D}^{+} + λ ( {Q}_{X}^{+} + {Q}_{Y}^{+} + {Q}_{Z}^{+} ) \qquad ( 57 )$$

$$And$$

$${Q}^{-} = λ ( {Q}_{X}^{-} + {Q}_{Y}^{-} + {Q}_{Z}^{-} ) \qquad ( 58 )$$

Q⁺ and Q⁻ are symmetrical matrices with positive elements.

According to (30),

$$ε ( f ) = {ε}_{D} ( f ) + λ {ε}_{R} ( f ) = \frac{1}{2} {f}^{T} Qf + {c}^{T} f \qquad ( 59 )$$

A formalism related to expression (11) is established. As shown in (15), according to this formalism, the vector f is updated according to the expression:

$${f}^{k} ← {f}^{k - 1} ⊙ \frac{{Q}^{-} {f}^{k - 1} + {c}^{-}}{{Q}^{+} {f}^{k - 1} + {c}^{+}} , \qquad ( 60 )$$

$$knowing that c = {c}^{-} \qquad ( 61 )$$

$$Thus$$

$${f}^{k} ← {f}^{k - 1} ⊙ \frac{{Q}^{-} {f}^{k - 1} + c}{{Q}^{+} {f}^{k - 1}} \qquad ( 62 )$$

Expression (61) can be derived as follows:

$${F}^{k} ← {F}^{k - 1} ⊙ \frac{{Q}^{-} ( {F}^{k - 1} ) + {P}_{R} * M}{{Q}^{+} ( {F}^{k - 1} )} \qquad ( 63 )$$

$$with$$

$${Q}^{-} ( {F}^{k - 1} ) = λ ( {D}_{X}^{R +} * ( {Γ}^{′} ⊙ {D}_{X}^{-} * {F}^{k - 1} ) + {D}_{X}^{R -} * ( {Γ}^{′} ⊙ {D}_{X}^{+} * {F}^{k - 1} ) ) + λ ( {D}_{Y}^{R +} * {Γ}^{′} ⊙ ( {D}_{Y}^{-} * {F}^{k - 1} ) + {D}_{Y}^{R -} * {Γ}^{′} ⊙ ( {D}_{Y}^{+} * {F}^{k - 1} ) ) + λ ( {D}_{Z}^{R +} * {Γ}^{′} ⊙ ( {D}_{Z}^{-} * {F}^{k - 1} ) + {D}_{Z}^{R -} * ( {Γ}^{′} ⊙ {D}_{Z}^{+} ) ) \qquad ( 64 )$$

$${Q}^{+} ( {F}^{k - 1} ) = {P}_{R} * P * {F}^{k - 1} + λ ( {D}_{X}^{R +} * ( {Γ}^{′} ⊙ {D}_{X}^{+} * {F}^{k - 1} ) + {D}_{X}^{R -} * ( {Γ}^{′} ⊙ {D}_{X}^{-} * {F}^{k - 1} ) ) + λ ( {D}_{Y}^{R +} * ( {Γ}^{′} . {D}_{Y}^{+} ) + {D}_{Y}^{R -} * ( {Γ}^{′} ⊙ {D}_{Y}^{-} * {F}^{k - 1} ) ) + λ ( {D}_{Z}^{R +} * ( {Γ}^{′} ⊙ {D}_{Z}^{+} * {F}^{k - 1} ) + {D}_{Z}^{R +} * ( {Γ}^{′} ⊙ {D}_{Z}^{+} * {F}^{k - 1} ) ) \qquad ( 65 )$$

Γ′ contains the diagonal elements of the matrix Γ spatially distributed so that at each coordinate rₙ:

$${Γ}^{′} ( {r}_{n} ) = 1 / {\vert G ( {F}^{k - 1} ( {r}_{n} ) ) \vert}_{2}$$

Q⁻(F^{k-1}) and Q⁺(F^{k-1}) are operators applied to the fluorescence map F^{k-1}, as defined in (64) and (65) respectively.

Expression (63) provides a formula for updating the fluorescence map F between two successive iterations F^{k-1} and F^{k}. Using a more general notation, involving the adjoint model H′ of the forward model, applied to the measurements,

$${F}^{k} ← {F}^{k - 1} ⊙ \frac{{Q}^{-} ( {F}^{k - 1} ) + {H}^{′} ( M )}{{Q}^{+} ( {F}^{k - 1} )} \qquad ( 66 )$$

$$and$$

$${Q}^{+} ( {F}^{k - 1} ) = {H}^{′} ( H ( {F}^{k - 1} ) ) + λ ( {D}_{X}^{R +} * ( {Γ}^{′} ⊙ {D}_{X}^{+} * {F}^{k - 1} ) + {D}_{X}^{R -} * ( {Γ}^{′} ⊙ {D}_{X}^{-} * {F}^{k - 1} ) ) + λ ( {D}_{Y}^{R +} * ( {Γ}^{′} ⊙ {D}_{Y}^{+} ) + {D}_{Y}^{R -} * ( {Γ}^{′} ⊙ {D}_{Y}^{-} * {F}^{k - 1} ) ) + λ ( {D}_{Z}^{R +} * ( {Γ}^{′} ⊙ {D}_{Z}^{+} * {F}^{k - 1} ) + {D}_{Z}^{R +} * ( {Γ}^{′} ⊙ {D}_{Z}^{+} * {F}^{k - 1} ) ) \qquad ( 67 )$$

In this example:

$${H}^{′} ( M ) = {P}_{R} * P \qquad ( 68 )$$

$$and {H}^{′} ( P * {F}^{k - 1} ) = {P}_{R} * P * {F}^{k - 1} \qquad ( 69 )$$

The notation D_{X}^{R+} means D_{X}⁺ returned, i.e. after applying a transformation by central symmetry, of the matrix D_{X}⁺.

Looking at the effect of matrices (38) to (41), it can be observed that:
The convolution of F with D_{Δ}⁺ leaves F unchanged.
The convolution of F with D_{Δ}^{R+} leaves F unchanged.
The convolution of F with D_{Δ}⁻ shifts F in the negative direction Δ, preferably by one unit.
The convolution of F with D_{Δ}^{R-} shifts F in the positive direction Δ, preferably by one unit.

In the case of a three-dimensional fluorescence map, Δ corresponds successively to X, Y and Z.

The final calculation is very simple

$${Q}^{+} ( {F}^{k - 1} ) = ( {P}_{R} * P ) * {F}^{k - 1} + λ [ 3 {Γ}^{′} ⊙ {F}^{k - 1} + {S}_{x \to } [ {Γ}^{′} ⊙ {S}_{← x} {F}^{k - 1} ] + {S}_{y \to } [ {Γ}^{′} ⊙ {S}_{← y} {F}^{k - 1} ] + {S}_{z \to } [ {Γ}^{′} ⊙ {S}_{← z} {F}^{k - 1} ] ] = {H}^{′} ( H ( {F}^{k - 1} ) ) + λ [ 3 {Γ}^{′} ⊙ {F}^{k - 1} + {S}_{x \to } [ {Γ}^{′} ⊙ {S}_{← x} {F}^{k - 1} ] + {S}_{y \to } [ {Γ}^{′} ⊙ {S}_{← y} {F}^{k - 1} ] + {S}_{z \to } [ {Γ}^{′} ⊙ {S}_{← z} {F}^{k - 1} ] ] \qquad ( 70 )$$

$${Q}^{-} ( {F}^{k - 1} ) = λ [ {Γ}^{′} ⊙ ( {S}_{← x} {F}^{k - 1} + {S}_{← y} {F}^{k - 1} + {S}_{← z} {F}^{k - 1} ) + {S}_{x \to } [ {Γ}^{′} ⊙ {F}^{k - 1} ] + {S}_{y \to } [ {Γ}^{′} ⊙ {F}^{k - 1} ] + {S}_{z \to } [ {Γ}^{′} ⊙ {F}^{k - 1} ] ] \qquad ( 71 )$$

S_{x→} is a shift operator in the positive X direction (similarly, S_{y→} shifts towards the positive Y direction and S_{z→} shifts towards the positive Z direction).
S_{←x} is a shift operator in the negative X direction (similarly, S_{←y} shifts towards the negative Y direction and S_{←z} shifts towards the negative Z direction).

Regardless of the chosen axis and direction, the shift is performed in a number of units equal to or close to 1, typically between 1 and 10 or preferably between 1 and 5.

Expressions (70) and (71) can be written as follows:

$${Q}^{+} ( {F}^{k - 1} ) = {H}^{′} ( H ( {F}^{k - 1} ) ) + λ [ n {Γ}^{′} ⊙ {F}^{k - 1} + {\sum }_{Δ} {S}_{Δ \to } [ {Γ}^{′} ⊙ {S}_{← Δ} {F}^{k - 1} ] ] \qquad ( 72 )$$

$${Q}^{-} ( {F}^{k - 1} ) = λ [ {Γ}^{′} ⊙ {\sum }_{Δ} {S}_{← Δ} {F}^{k - 1} + {\sum }_{Δ} {S}_{Δ \to } [ {Γ}^{′} ⊙ {F}^{k - 1} ] ] \qquad ( 73 )$$

Where Δ corresponds to each axis of the reference frame under consideration. One or more axes can be considered, usually two (two-dimensional spatial distribution) or three (3D spatial distribution). In (71), n corresponds to the number of axes considered.

One advantage of updating according to update expressions (62) or (63) or (66) is that they are simple to implement, from a memory standpoint. Updating is achieved by shifting the F^{k-1} fluorescence map in the three directions: X, Y and Z.

A special feature of the invention is that, when the regularization component is taken into account, the fluorescence map is successively shifted in both the positive or negative directions along the three axes of the reference frame. These operations require very little computing power.

For example, the calculation of S_{x→}[Γ′⊙S_{←x}F^{k-1}] is a simple calculation, obtained by:
shifting all the elements of F^{k-1}, associated with a coordinate (x, y, z) one step towards negative X direction: this produces the shifted fluorescence map S_{←x}F^{k-1}
multiplying, element-wise, each element of S^{←x}F^{k-1} by Γ′;
shifting all elements of [Γ′⊙S_{←x}F^{k-1}], associated with a coordinate (x, y, z) one step towards the positive X direction.

The update is performed:
by computing Q_{D}⁺, from the forward model operator and the adjoint operator of the forward model, with Q_{D}⁺=P_{R}*P, knowing that this value is identical for all iterations;
by calculating c⁻=−c=P_{R}*M from the adjoint operator, knowing that this value is identical for all iterations;
and, during each iteration, by calculating Q⁻(F^{k-1}) and Q⁺(F^{k-1}) related to the regularization, knowing that these components can be obtained, without requiring significant computing power, by successive shifts of the fluorescence map F^{k-1} along the three axes X, Y and Z, generally by one increment, either in the positive or negative direction.

The formalism described in connection with expressions (61) to (73) enables the fluorescence map to be determined iteratively, using a simple-to-implement and low-resource-consuming update formula, as seen previously.

FIG. 4 shows the main steps in implementing a method according to the invention, in an example corresponding to the reconstruction of a fluorescence map (spatial distribution of fluorescence) of an object.

### Step 100: Object Illumination.

In step 100, the object 10 is illuminated by the light source 11 in an illumination spectral band.

In the example described, the illumination spectral band is an excitation spectral band of a fluorophore potentially present in the object.

The object can be interposed between the light source 11 and the image sensor 15, which corresponds to an acquisition configuration usually referred to as “transmission”. Alternatively, acquisition can be performed in reflection or backscatter mode, with the light source 11 and image sensor 15 facing the object.

### Step 110: Acquisition of Object Images

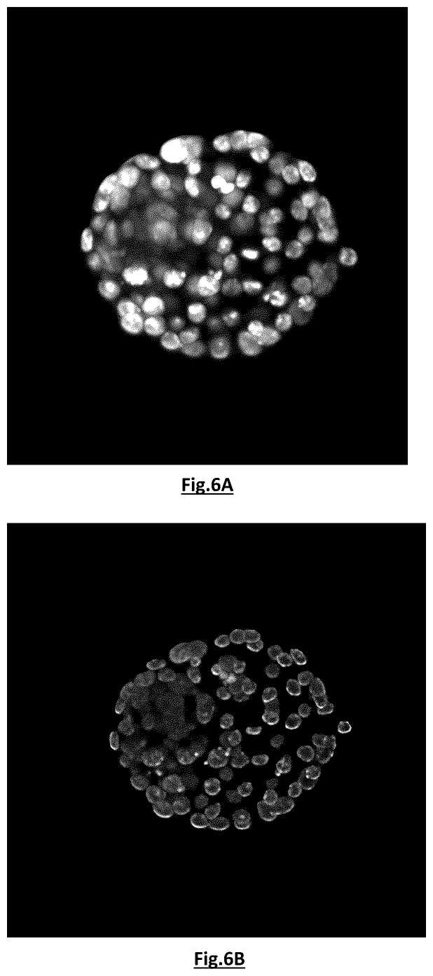

During this step, one or more elementary images M₁ . . . Mᵢ . . . M_{I} of the object are acquired at different depths. FIG. 5 illustrates an acquisition configuration in which the focal plane of the image sensor is successively moved to different depths within the object, corresponding to a preferred embodiment. The light source remains fixed. The image sensor acquires as many images as focal lengths, each focal length being associated with a depth i in the object. This produces elementary images M₁ . . . Mᵢ . . . , M_{I}, I corresponding to the number of elementary images. The elementary images M₁ . . . Mᵢ . . . M_{I} are respectively associated with the depths d₁ . . . dᵢ . . . d_{I}. In the following, the elementary images are combined to form an acquired image notedM: this is a three-dimensional image of the object. The acquired image is discretized into voxels, called image voxels M(r′), each image voxel being a pixel of an elementary image Mₙ forming the acquired image M.

Alternatively:
the image sensor has a fixed focal length and is moved relative to the object, so that the focal plane is successively moved to different depths d₁ . . . dᵢ . . . d_{I} into the object.
the image sensor remains fixed while a light source, emitting a narrow light blade, is used. The light source is then translated relative to the object, preferably parallel to the optical axis. Thus, during each illumination, a layer of the object parallel to the image sensor's focal plane is illuminated, the thickness smaller than the distance between two successive depths dᵢ, dᵢ₋₁. The sensor acquires an image at each position of the light source. Different images are thus formed in succession, corresponding to different object depths.

Generally speaking, step 110 aims to obtain different images M₁ . . . Mᵢ . . . M_{I} representative of different depths of the object d₁ . . . dᵢ . . . d_{I}. By acquiring images with focal planes at different depths, it is possible to obtain sharper images of the fluorescent sources in the object. The result is a more accurate reconstruction. The measurements correspond to a forward model applied to the fluorescence map.

The following steps are carried out by the processing unit 20, which comprises a microprocessor connected to a memory. The memory contains instructions for implementing the processing described below. The memory of the processing unit contains the images M₁ . . . Mᵢ . . . M_{I} acquired during step 110.

### Step 120: Initialization

In this step, the spatial distribution of fluorescence in the object is initialized. Each element F(r) takes on a randomly determined or predefined initial value F⁰ (r). Preferably, initialization is performed so that F⁰=P_{R}*M: this is the application of the adjoint operator P_{R} of the forward model, to the measurements. More generally, F⁰=H′(M).

Step 130: vector formation f⁰. In this step, each element of F⁰(r) forms a vector f⁰.
Step 140: formation of matrices Q⁺, Q⁻, and vectors c⁺ and c⁻: these matrices and vectors constitute the input data for the algorithm. They are determined as a function of the PSF, the sensor measurements M and the norm of the spatial gradient considered in the regularization element.
Step 150: Update the vector f^{k} based on the vector f^{k-1} from a previous iteration or, in the first iteration from the initialization (step 130). The update formula is:

$${f}^{k} ← {f}^{k - 1} ⊙ \frac{{Q}^{-} {f}^{k - 1} - c}{{Q}^{+} {f}^{k - 1}} \qquad ( 62 )$$

Expression (62) corresponds to a fluorescence map in vector form.

The vectorization phase (step 130) is optional. The fluorescence map can be expressed as a matrix, 2D or 3D, with the update formula being:

$${F}^{k} ← {F}^{k - 1} ⊙ \frac{{Q}^{-} ( {F}^{k - 1} ) + {P}_{R} * M}{{Q}^{+} ( {F}^{k - 1} )} \qquad ( 63 )$$

More generally, the update formula is (66).

Step 160: repeat step 150 until an iteration stop criterion is reached. The iteration stop criterion is a predetermined number of iterations or a comparison between two vectors f^{k} and f^{k-1} resulting from two successive iterations (or between two successive fluorescence maps F^{k} and F^{k-1}).

The invention was used to reconstruct a fluorescence map of a mouse embryo at blastocyte stage. The nucleus of each cell was fluorescently labeled (Draq5-registered trademark) excited at 625 nm. Fifty image planes were acquired, spaced 2 μm apart. The diameter of the embryo was 90 μm. The size of each pixel, in object space, was 108 nm.

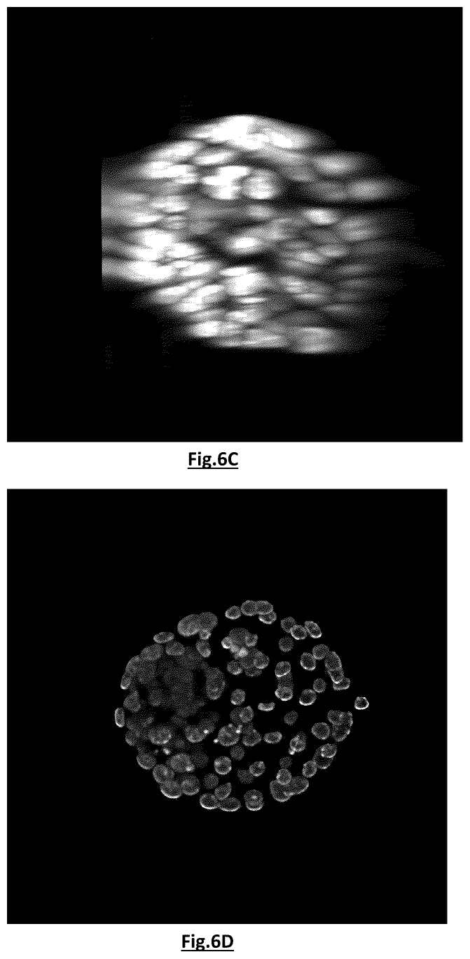

The fluorescence map of the sample was reconstructed both without and with regularization. FIGS. 6A and 6C show views along the XY plane (parallel to the image sensor plane) and XZ plane (perpendicular to the image sensor plane), without implementing regularization. The updating formula is as explained in (16). FIGS. 6B and 6D show views along the XY plane (parallel to the image sensor plane) and XZ plane (perpendicular to the image sensor plane) planes, with regularization. It can be seen that regularization results in a reconstruction that is more representative of reality.

An example of the reconstruction of a spatial fluorescence distribution has been described above: the characteristic of the object is the intensity of fluorescent light emission.

However, the invention can also be applied to other reconstructions of spatial distributions. For example, the attenuation of an object to ionizing radiation in a given energy range can be reconstructed when X-ray tomography measurements are taken around the object. In this case, the forward model implements a Radon transform, which is also a linear operator applied to the unknowns to be determined, namely the absorbance of voxels in the sample. Thus, the F map to be reconstructed is the absorbance map for different voxels of the sample. Measurements M correspond to the integral of absorbance values along linear paths between an X-ray source and detector pixels. Measurements can be estimated according to a linear prediction model, forming the forward model: \hat{M}= [symbol] (F) where [symbol] is a Radon transform. The data fidelity error is calculated using the adjoint operator of the Radon transform [symbol] ′(M), applied to the measurements.

The invention can also be applied to estimating the optical absorption of an object, the difference being that the emission wavelength of the light source corresponds to the wavelength of the photons detected by the image sensor. The characteristic is therefore the optical absorption at different object coordinates.

The characteristic can be part of an image, with the aim of reconstructing a sharp image from a blurred one.

Thus, the characteristic can represent an optical property of an object, or a characteristic of attenuation or reflection or backscattering or attenuation of a wave, within the object. This may be an electromagnetic wave (light wave, X-ray or gamma ray) or an acoustic wave, with applications in ultrasound imaging. More generally, the characteristic may represent a response of the object to a wave to which it is exposed.

The invention can also be applied to an image deconvolution, for example the application of a filter with a known PSF (Point Spread Function).

In all cases, during each iteration, the regularization is incorporated through a combination of elements, each element corresponding to a shift in the spatial distribution along at least one axis of the reference frame in which the object coordinates are defined.

1. A method of reconstructing a spatial distribution of a characteristic within an object, wherein the object is discretized into spatial coordinates within a reference frame that comprises at least one axis, the method comprising:
a) acquiring measurements by a sensor, positioned in front of the object, and defining a forward model to estimate said measurements, the forward model comprising a linear operator, applied to the spatial distribution of the characteristic;
b) reconstructing the spatial distribution of the characteristic of the object, at each spatial coordinate, by minimizing an error during iterations, where each iteration is assigned an index, each iteration comprising an update of the spatial distribution of the characteristic of the object, the first iteration starting from an initial spatial distribution,
wherein in step b), minimizing the error comprises calculating:
a data fidelity term, which represents a deviation between the acquired measurements and the measurements estimated by the forward model; and
a regularization term, calculated with a sum of a norm of a spatial gradient of the characteristic, computed at different coordinates in the object;
wherein each iteration comprises updating a previous spatial distribution, which is either the initial spatial distribution or the spatial distribution obtained from a previous iteration;
wherein updating the previous spatial distribution comprises calculating a product, for each spatial coordinate, of
the previous spatial distribution;
an adjoint operator of the forward model, applied to the acquired measurements;
for at least one axis of the reference frame, an element-wise multiplication of:
the previous spatial distribution translated, along said axis of the reference frame, by at least one unit, in an increasing direction; and
the previous spatial distribution translated, along said axis of the reference frame, by at least one unit, in a decreasing direction.

2. The method according to claim 1, wherein updating the previous spatial distribution comprises, for each spatial coordinate, multiplying the previous spatial distribution by a linear combination of products, each product being associated with an axis of the reference frame (X,Y,Z), each product comprising an element-wise multiplication of:
the previous spatial distribution translated, along the axis of the reference frame, by at least one unit, in an increasing direction;
the previous spatial distribution translated, along the axis of the reference frame, by at least one unit, in a decreasing direction.

3. The method according to claim 1, wherein each element-wise multiplication, for each spatial coordinate, comprises calculating the inverse of a norm of a spatial gradient of the previous distribution for said spatial coordinate.

4. The method according to claim 3, wherein updating the previous spatial distribution comprises calculating:
$${F}^{k} ← {F}^{k - 1} ⊙ \frac{{Q}^{-} ( {F}^{k - 1} ) + {H}^{′} ( M )}{{Q}^{+} ( {F}^{k - 1} )}$$
where:
F^{k-1} is the previous spatial distribution;
⊙ is the element-wise multiplication operator;
$${Q}^{+} ( {F}^{k - 1} ) = {H}^{′} ( H ( {F}^{k - 1} ) ) + λ [ n {Γ}^{′} ⊙ {F}^{k - 1} + {\sum }_{Δ} {S}_{Δ \to } [ {Γ}^{′} ⊙ {S}_{← Δ} {F}^{k - 1} ] ] ;$$
$${Q}^{-} ( {F}^{k - 1} ) = λ [ {Γ}^{′} ⊙ {\sum }_{Δ} {S}_{← Δ} {F}^{k - 1} + {\sum }_{Δ} {S}_{Δ \to } [ {Γ}^{′} ⊙ {F}^{k - 1} ] ] ;$$
M comprises to the measurements acquired;
Γ′ is a spatial distribution of the inverse of a norm of a spatial gradient of the previous spatial distribution, in each spatial coordinate;
Δ is the axis of the reference frame;
S^{←Δ} is an operator for shifting one or more units along the axis of reference frame, in the decreasing direction;
S_{Δ→} is an operator for shifting one or more units along the axis of reference frame, in an increasing direction;
n corresponds to the number of axes considered;
λ is a positive real;
H is the forward model operator
H′ is the adjoint operator of the forward model.

5. The method according to claim 1, wherein step a) comprises forming at least one image of the object, the image forming a spatial distribution of measurements acquired by the sensor.

6. The method according to claim 5, wherein:
the sensor is an image sensor, configured to form an image of the object at an emission wavelength;
the object comprises a fluorophore emitting light at the emission wavelength when illuminated at an excitation wavelength;
in step a), at least one image of the object is acquired when the object is illuminated at the excitation wavelength, different from the emission wavelength, so that each measurement corresponds to an amount of light emitted by the fluorophore at different spatial coordinates within the object.

7. The method according to claim 5, wherein;
the sensor is an image sensor, configured to form an image of the object at an emission wavelength;
the object absorbs light at the emission wavelength,
in step a), at least one image of the object is acquired when the object is illuminated at the emission wavelength, so that each measurement corresponds to an amount of light absorbed at different coordinates in the object.

8. The method according to claim 5, wherein;
the sensor is configured to detect an ionizing X-ray or gamma ray;
in step a), the object is irradiated with an X-ray or gamma-ray beam, so that each measurement corresponds to an absorption of the X-ray or gamma-ray beam by the object.

9. The method according to claim 1, wherein the characteristic is a characteristic of emission or reflection or backscattering or absorption of an electromagnetic wave or acoustic wave.

10. A processing unit, configured to implement step b) of a method according to claim 1, using measurements acquired by a sensor, positioned in front of an object, so as to obtain a spatial distribution of a characteristic within the object.

11. A measurement device, configured to reconstruct a spatial distribution of a characteristic within an object, the object being discretized into spatial coordinates within a reference frame, the measurement device comprising;
a sensor, configured to be positioned in front of the object, and configured to acquire measurements;
a processing unit, configured to apply a forward model to estimate said acquired measurements, the forward model comprising a linear operator, applied to the spatial distribution of the characteristic;
wherein the processing unit is configured to implement step b) of the method according to claim 1.
